(19) United States
(12) Patent Application Publication
(10) Pub. No.: US 2013/0156399 A1
(43) Pub. Date: Jun. 20, 2013

(54) EMBEDDING CONTENT IN RICH MEDIA

(71) Applicants: Joseph M. Joy, Redmond, WA (US); Tanuja Joshi, Punchavati Pashan (IN); Eric J. Stollnitz, Kirkland, WA (US); Kanchan Rajanna, Seattle, WA (US); Ajay Manchepalli, Bangalore (IN); Naren Datha, Bangalore (IN)

(72) Inventors: Joseph M. Joy, Redmond, WA (US); Tanuja Joshi, Punchavati Pashan (IN); Eric J. Stollnitz, Kirkland, WA (US); Kanchan Rajanna, Seattle, WA (US); Ajay Manchepalli, Bangalore (IN); Naren Datha, Bangalore (IN)

(73) Assignee: Microsoft Corporation, Redmond, WA (US)

(21) Appl. No.: 13/330,696

(22) Filed: Dec. 20, 2011

(51) Int. Cl. H04N 9/80

(52) U.S. Cl. 386/239; 386/E09.011

(57) ABSTRACT

Methods and systems for embedding content in rich media are described herein. The method includes populating embedded content from a data stream into an experience using an artifact embedding system. The method also includes binding the embedded content to a behavior from a framework of preselected behaviors using an embedded object manager.

### BACKGROUND

Interactive exploration techniques are often used for the visualization of complex data. These techniques generally entail presenting information in an organized, often hierarchical manner, which allows a user to intelligently search through the data. For example, two-dimensional (2D) and three-dimensional (3D) browsable maps may utilize interactive mapping software that enables users to explore a vast space with customizable data layers and views. As another example, a software application called Photosynth® may be used for the exploration of collections of images embedded in a recreated 3D space. Yet another example is the so-called pivot control that enables a visually-rich, interactive exploration of large collections of items by “pivoting” on selected dimensions or facets. Further, interactive exploration may be enabled by the use of scripted fly-throughs, which allow a user to virtually move through a model of a scene, such as a recreated 2D or 3D space, as if they are actually inside the scene or moving through the scene.

Many forms of interactive exploration rely on the use of embedded content within the image data in order to tell a particular story that makes up the narrative. However, there are no standards for embedding content within media, including videos, images, and complex media. Therefore, many applications rely on the use of media-specific and platform-specific application programming interfaces (APIs) to embed or overlay content within such media. Furthermore, there is no standard method for enabling scripted fly-throughs through multiple types of media with embedded content. Thus, instances of embedded content are generally implemented by specific websites and applications dedicated to particular forms of media.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for embedding content in rich media. The method includes populating embedded content from a data stream into an experience using an artifact embedding system. The method also includes binding the embedded content to a behavior from a framework of preselected behaviors using an embedded object manager.

Another embodiment provides a system for embedding content in rich media. The system includes an artifact embedding system configured to obtain data from a data source, map the data into a desired form using a data mapper, and convert the data into a desired layout using a layout engine. The artifact embedding system is also configured to embed the data within rich media, wherein the data includes embedded content, and bind the data to a behavior from a framework of preselected behaviors using an embedded object manager.

In addition, another embodiment provides one or more tangible, non-transitory, computer-readable storage media for storing computer-readable instructions. The computer-readable instructions provide an artifact embedding system when executed by one or more processing devices. The computer-readable instructions include code configured to obtain data from a data source using the artifact embedding module, map the data into a desired format, and determine a desired layout and desired parameters for the data. The computer-readable instructions also include code configured to populate the data within rich media according to the desired layout and the desired parameters and bind the data to any of a number of preselected behaviors.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A is a block diagram of an exemplary experience stream that may be used to enable and construct RINs for playback to the user;

FIG. 1B is a block diagram of a reference player system that may be utilized to perform playback of RINs;

FIG. 2 is a block diagram of an artifact embedding system that may be used to embed artifacts within rich media;

FIG. 3 is a block diagram of an exemplary computing system that may be used to implement the artifact embedding system;

FIG. 4 is a process flow diagram showing a method for embedding content in rich media;

FIG. 5 is a block diagram of a method for embedding artifacts within rich media and processing the embedded artifact (EA) state; and

FIG. 6 is a block diagram showing a tangible, non-transitory, computer-readable medium that stores code adapted to allow for the embedding of content in rich media.

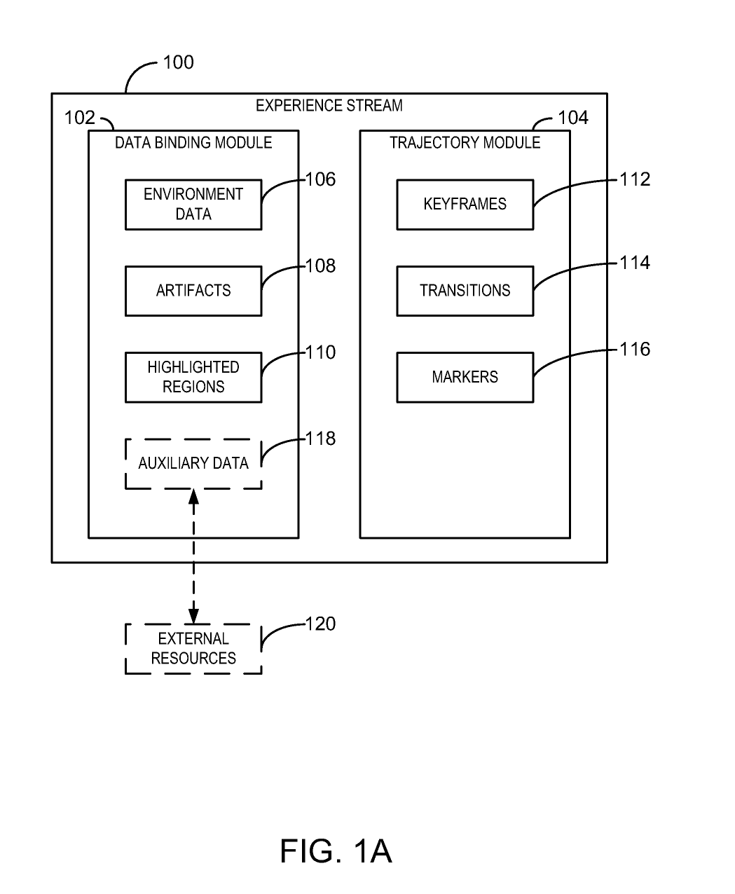

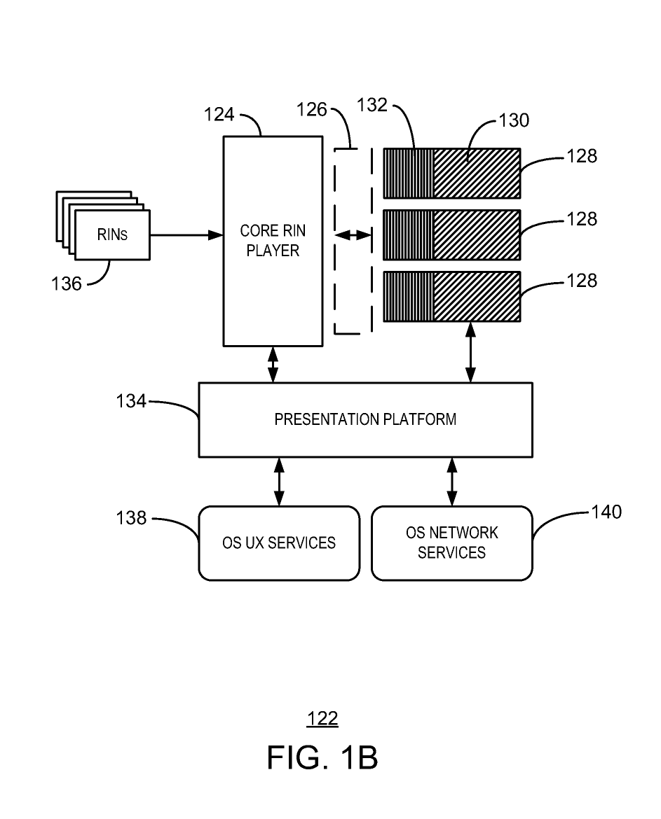

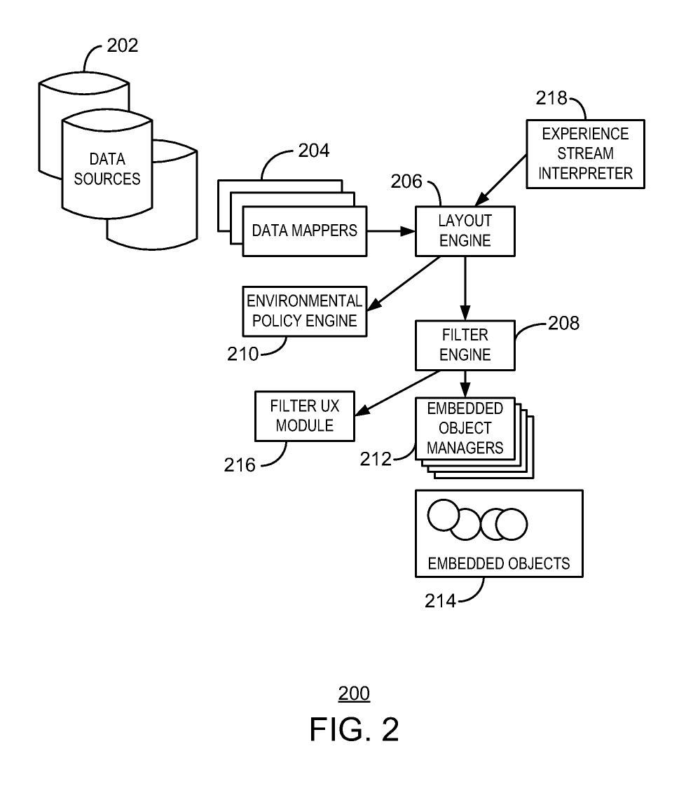

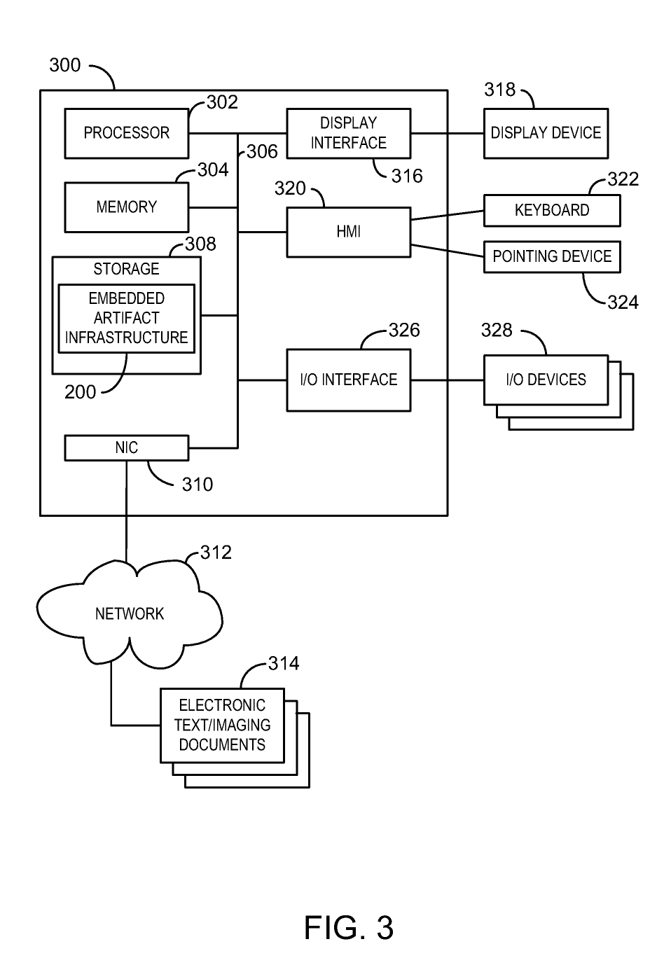

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, interactive exploration may be enabled by the use of scripted fly-throughs, which allow a user to virtually move through a model of a scene, such as a recreated 2D or 3D space, as if they are actually inside the scene or moving through the scene. In some cases, scripting may be used to control the visibility and state of the embedded content. The logical state of all embedded content may be concisely represented within an interactive exploration medium, so that the embedded content state may be restored and become part of a scripted fly-through experience. In various embodiments, state representations include serializable data that has universal portions that apply to a wide variety of embedded content, as well as custom portions that encode the state of specialized embedded content.

Further, as discussed above, many forms of interactive exploration, or rich media, rely on the use of embedded content within the rich media in order to tell a particular story that makes up the narrative. According to the system and method disclosed herein, a particular type of rich media called a “rich interactive narrative” (RIN) may utilize such embedded content, or embedded artifacts. The embedded content may help tell a story and provide additional opportunities for exploration as a user traverses through the underlying rich media, such as maps, image sets, and panoramas. Moreover, according to the RIN data model, the data that represents the path through the media may be referred to as an “experience stream” (ES). Thus one can have a map ES, an image ES, or a panorama ES, among others.

In general, embodiments of the RIN data model are made up of abstract objects that can include, but are not limited to, narratives, segments, screenplays, resource tables, experience streams, sequence markers, highlighted regions, artifacts, keyframe sequences, and keyframes. The RIN data model provides seamless transitions between narrated, guided walkthroughs of arbitrary media types and user-explorable content of the media in an extensible manner. In the abstract, the RIN data model can be envisioned as a narrative that runs like a movie with a sequence of scenes, each including one or more interactive environments. A user can stop the narrative, explore the environment associated with the current scene or any other desired scenes, and then resume the narrative.

As described herein, ESs are data constructs that may be used by the RIN data model as basic building blocks. Different types of ESs, such as the aforementioned image and map ESs, may be combined in a variety of ways to enable or construct a large number of RIN scenarios for presenting interactive narratives to the user. Combinations of various ES types may contain or have access to all the information required to define and populate a particular RIN, as well as the information that charts an animated and interactive course or path through each RIN. A RIN player interprets the RIN data model, and can dynamically load experience providers (ES providers) for each type of ES. The ES providers are responsible for rendering the scripted and interactive experience, or rich media, for each type of ES. In order to achieve this, the various ES providers also provide user interface (UI) controls or toolbars that enable user interaction along the interactive path representing the interactive narrative provided by each RIN.

Examples of ES types include, but are not limited, image ESs, content browser ESs, zoomable media ESs, relationship graph ESs, and toolbar ESs. Moreover, depending upon the particular type of ES, each ES may be dynamically bound to specific data, such as the results of a query, particular images or text, videos, or music, along with the functionality to provide a replay or display of that data during playback of the RIN. For example, according to embodiments disclosed herein, each ES may be dynamically bound to a variety of embedded artifacts within each ES type. Embedded artifacts may be passive objects, or may possess behaviors of their own.

Embodiments disclosed herein set forth a method and system for embedding artifacts from multiple streams of data in rich media and binding the embedded artifacts to an extensible set of behaviors in a platform-independent manner. The environment within which the artifacts are embedded may be extensible, meaning that it may be easily modified by adding or changing content, perhaps even at runtime. For example, the environment may include, but is not limited to, images, fixed layout documents, movable layout documents, video, deep zoom multi-scale imagery, panoramas, maps, three-dimensional (3D) environments, and galleries of media, often referred to as content browsers.

In various embodiments, the method and system disclosed herein may enable the keyframing of the state of embedded artifacts. As used herein, the term “keyframing” refers to a process of assigning specific parameter values, such as position, to an object, e.g., an embedded artifact, at a specific point in time and space. For example, individual keyframes of such an object may define the starting and ending points of a smooth transition or movement of the object within a rich media environment. In various embodiments, a keyframe may be referred to as a “small state” representation of an embedded artifact. Moreover, once the state of an embedded artifact has been keyframed, the state may be scripted as part of a fly-through or a RIN.

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1A is a block diagram of an exemplary experience stream 100 that may be used to enable and construct RINs for playback to the user. In general, a RIN may be composed of several elements, including a list of scenes, a start scene, and a list of RIN segments. For the list of scenes, each scene may be analogous to a scene in a DVD movie. Scenes are a sequentially-running portion of the RIN. Scene boundaries may disappear when running a RIN from end to end. However, in general, navigation among scenes can be non-linear. A start scene is typically a “menu” scene that is a launching point for the RIN, analogous to the menu of a DVD movie. A RIN segment contains details for instantiating and rendering a linear portion of a RIN. A segment is made up of a list of ESs and a list of layout constraints, as well as additional metadata. For the list of ESs, each ES defines a fly-through path through environments, such as Virtual Earth®, Photosynth®, multi-resolution images, and Web browsers, as well as traditional images, audio, and video. Furthermore, the term “environment” is used herein to include any combination of images, video, and audio. For the list of layout constraints, layout constraints among the ES viewports indicate z-order and 2D or 3D layout preferences, as well as specifications about how to mix audio from multiple ESs. These constraints enable the proper use of both screen real estate and audio real estate by the various ESs used by a particular RIN during playback.

Metadata in a segment determines when each particular ES may become visible or audible, as well as when the ES may disappear. Segments may also include additional metadata. For example, metadata of a segment may specify that a subsection of an ES is to be played, or that interactivity capabilities of the ES are to be enabled or disabled relative to some user interaction or to some point that is reached during playback of the RIN. Segment metadata can also bind user actions to ES viewports. For example, clicking on a viewport may cause a jump to another scene, or make some other ES appear or disappear. Each ES may also be viewable, audible, or otherwise accessible across multiple scenes to enable seamless transitions between scenes, similarly to the transitions between the scenes of a movie.

Various types of experiences have 2D or 3D viewports through which their corresponding ESs are experienced. Various types of experiences also support user pause-and-explore type operations while interacting with various RINs. Further, some experiences may not have viewports but, rather, may consist of audio, such as, for example, a voiced-over narrative or a background score. In addition, some experiences may also represent toolbars or controls for enabling actions such as volume control, audio or video playback, or pause-and-explore operations, among others. Each ES may contain provider information that binds the ES to the ES provider, which is code that understands and is capable of rendering or displaying the specific experience and causing it to play an ES on demand. A simple example of an ES provider is code that interprets keyframe data consisting of media operations (such as pause, seek, or play) and uses underlying audio and video media APIs to execute such media operations.

As noted above, the exemplary experience stream 100 may be used to provide basic organization for constructing RINs for playback to the user. As shown in FIG. 1A, the ES 100 may be composed of a data binding module 102 and a trajectory module 104. The data binding module 102 may include environment data 106, as well as artifacts 108 and highlighted regions 110. The trajectory module 104 may include keyframes 112, transitions 114, and markers 116. The ES 100 may also include optional auxiliary data 118 within the data binding module 102. The auxiliary data 118 may include provider information, as well as references to external resources 120. The external resources 120 may include, for example, metadata, media, references to external services, external code, databases, or applications that are bound to the ES 100 via the auxiliary data 118 for authoring, processing, or providing playback of specific experience streams.

In some embodiments, the trajectory module 104 may be defined partly by the set of keyframes 112. Each keyframe 112 may capture the logical state of the experience at a particular point of time. These times may be in specific units or relative units, or may be gated by external events. The keyframes 112 capture the information state of an experience in a RIN. An example of an information state for a map experience may be the world coordinates (e.g., latitude, longitude, or elevation) of a region under consideration, as well as additional style (e.g., aerial or road) and camera parameters (e.g., angle or tilt). An example of an information state for a relationship graph experience may be the graph node under consideration, the properties used to generate the neighboring nodes, and any graph-specific style parameters. In addition, each keyframe 112 may also represent a particular environment-to-viewport mapping at a particular point in time. For example, for the map ES mentioned above, the mappings are straightforward transformations of rectangular regions in the image to the viewport.

The keyframes 112 may be bundled into keyframe sequences that make up the trajectory through the environment. The trajectory may be further defined by the transitions 114, which define how inter-keyframe interpolations are done. The transitions 114 may be broadly classified into smooth (continuous) and cut-scene (discontinuous) categories, and the interpolation/transition mechanism for each keyframe sequence may vary from one sequence to the next. Moreover, the markers 116 may be embedded in the trajectory and may be used to mark a particular point in the logical sequence of a narrative. The markers 116 also have arbitrary metadata associated with them and may used for various purposes, such as indexing content and semantic annotation, as well as generalized synchronization and triggering. For example, content indexing is achieved by searching over embedded and indexed sequence markers. Further, semantic annotation is achieved by associating additional semantics with particular regions of content. A trajectory can also include markers that act as logical anchors that refer to external references. These anchors enable named external references to be brought into the narrative at predetermined points in the trajectory. Still further, a marker can be used to trigger a decision point where user input is solicited and the narrative may proceed based on this input.

Additionally, a trajectory may be much more than a simple traversal of an existing, or predefined, environment. Rather, the trajectory may include information that controls the evolution of the environment itself that is specific to the purpose of the RIN. For example, the animation and visibility of the artifacts 108 may be included in the trajectory. The most general view of a trajectory is that it represents the evolution of a user experience, both of the underlying model and of the user's view into that model.

The data binding module 102 within the ES 100 may be used to bind specific data or objects into an experience stream. In general, data bindings may refer to static or dynamically queried data that define and populate the environment through which an experience stream runs. Data bindings include environment data, as well as added artifacts and region highlights, which are a special kind of artifact. These items provide a very general way to populate and customize arbitrary environments, such as virtual earth, Photosynth®, and multi-resolution images, as well as traditional images, audio, and video. Moreover, the environment may also be a web browser or a subset of the World Wide Web.

As used herein, the term “embedded artifact” (EA) refers to any embedded content that is added to the underlying experience to provide additional information or additional opportunities for interactivity. For example, a map experience may contain embedded artifacts in the form of simple information blocks about particular points of interest. EAs may contain behaviors, or manipulatible states, which can be arbitrarily elaborated. For example, the aforementioned information blocks could take various states. For example, in a minimized state, the information blocks may show relatively few icons. In an inset state, the information blocks may be expanded to show more detail, perhaps through a combination of images, text, and graphics. In a maximized state, the information blocks may be expanded to occupy all or most of the available screen, with more detailed information presented. EAs can contain arbitrary media, and may even encapsulate entire RIN segments. When an ES is playing, i.e., the player is rendering a scripted fly-through of a particular experience, the ES may contain keyframes that also specify the states of contained EAs. For example, an ES that specifies a fly-through along a particular region in a map experience may also specify that particular EA information blocks are to be hidden or revealed at certain points of time along the narrative timeline. Furthermore, such an ES may specify that particular information blocks are to alternate between minimized, inset, and maximized states.

In various embodiments, highlights are a special kind of embedded artifact used to highlight certain parts of an experience in the context of a narrative. For example, a spotlight highlight may be used to call attention to particular features within an image ES. Moreover, highlights are typically closely associated with a particular narrative thread.

In various embodiments, the data binding module 102 may be used to bind, or embed, the artifacts 108 to the ES 100 in a variety of different ways. For example, the artifacts 108 may be embedded within media of the ES 100 by tightly anchoring the artifacts 108 to the media within the ES 100. A tightly anchored artifact is rendered such that is appears to be fixed to the underlying media. As the user or narrative navigates that media, the artifact's position also changes respective to the viewport, so that it remains at the same position with respect to the coordinate system of the underlying media.

The artifacts 108 may also be tethered to the ES 100 by loosely anchoring the artifacts 108 to the media within the ES 100. A loosely anchored artifact is rendered at a position which does not closely track the underlying media. For example, a loosely anchored artifact may appear as a panel at a fixed location in the viewport. However, the artifact is still anchored in the sense that it may be absent or present. If the artifact is present, its appearance is controlled by the proximity of the area shown in the viewport to its anchor position.

Further, the artifacts 108 may be floating within the ES 100, meaning that the artifacts 108 are not anchored to the media within the ES 100 at all but, rather, are rendered in a separate layer from the media. This enables rendering of the artifact to be achieved by a separate piece of code than the underlying experience provider. For example, the artifacts 108 may be floating in a tray of contextually-relevant information associated with the media of the ES 100. Moreover, the artifacts 108 may be bound to the media of the ES 100 using an artifact embedding system, as discussed further with respect to FIG. 2.

FIG. 1B is a block diagram of a reference player system 122 that may be utilized to perform playback of RINs. The reference player system 122 may include a core RIN player 124, which contains an internal orchestrator that interprets the screenplays of the RINs. The core RIN player 124 may also dynamically load the ES providers and send ES data to the ES providers.

The reference player system 122 may also include an ES provider interface 126 that communicably couples the core RIN player 124 to a number of third party ES providers 128. The third party ES providers 128 may include pre-existing third party visualization libraries 130 coupled to provider code 132 that implements the ES provider interface 126 on top of the APIs exposed by the pre-existing third party visualization libraries 130. Alternatively, the third party ES providers 128 may be written from scratch directly to the APIs exposed by a low-level presentation platform 134. In either case the provider code 132 is responsible for executing the ES provider functions, such as scripting a path through the experience based on the keyframes and other data present in the ES.

The core RIN player 124 may be configured to playback any of a number of RINs 136. This may be accomplished using the third party ES providers 128. The playback of the RINs 136 may be displayed to a user via the low-level presentation platform 134, such as Flash, Silverlight, or HTML-based browser, which provides the lower-level APIs to the client device. In various embodiments, the low-level presentation platform 134 may be configured to display the playback of the RINs 136 on any type of display device, such as, for example, a computer monitor, camera, television, projector, virtual reality display, or mobile device, among others. Furthermore, the low-level presentation platform 134 may utilize the services of the client devices' native operating system (OS) user experience (UX) services 138. The low-level presentation platform 134 may also leverage Operating system (OS) network services 140 to provide access to resources on the intranet and Internet.

FIG. 2 is a block diagram of an artifact embedding system 200 that may be used to embed artifacts within rich media. In various embodiments, the artifact embedding system 200 may be implemented within the data binding module 102 or the trajectory module 104, or both, discussed with respect to FIG. 1A. Moreover, the artifact embedding system 200 may be used to embed artifacts within the media of the ES 100, wherein the ES 100 may be used to construct a RIN for interactive playback by a user.

In some embodiments, the artifacts which may be embedded within the rich media may include both a “pasted on” part and an “overlay” part. The pasted on part may represent content that is “draped” or “painted on” the underlying experience stream, such as the ES 100. For example, the pasted on part may be a polygon draped over a three-dimensional (3D) representation of the Earth or a highlighted region of text. The pasted on part may have an intimate connection with the underlying embedding. Moreover, the pasted on part may be invisible and may be used to anchor the overlay part onto the underlying experience stream. Further, the overlay part may be tethered to the pasted on part and may be independent of the experience stream. For example, the overlay part may include push pins, information panels, and Popups of various kinds.

In some embodiments, the overlay part may contain a RIN itself, which can be played as a piece of media when the user interacts with the artifact. Further, any of the artifacts, or embedded content, may be a RIN that is embedded within rich media. For example, the embedded content may be a RIN that is embedded inside another, higher-level RIN.

According to the artifact embedding system 200, a search may be conducted to identify individual items of the embedded content, and the state of the individual items may be specified as part of a keyframe in a scripted or interactive session. Moreover, the embedded content may also take a form that is dependent on the relationship of the embedded content to the world-to-viewport mapping. World-to-viewport mapping represents a generalization of behaviors for altering or changing the form of the content embedded within different types of rich media. For example, the form of the content embedded within 3D spaces and maps may be changed by altering a zoom level or a distance from the viewpoint to the object in the world coordinates, or both.

The artifact embedding system 200 may include data sources 202. The data sources 202 may be used to provide the data that constitutes the embedded content, i.e., the embedded artifacts and highlights. The data sources 202 may include any of a number of different sources, including files contained in a database or data obtained online via online connections to data services. For example, the data may be obtained via standard interfaces, such as from a relational database management system using a programming language, such as the Structured Query Language (SQL), or from a Web protocol for querying and updating data, such as the Open Data Protocol (oData), among others.

A number of data mappers 204 may be included within the artifact embedding system 200. The data mappers 204 may include pluggable modules that map the data into a form that the components of the artifact embedding system 200 are expecting. In various embodiments, for example, the data mappers 204 may take the data sources 202 as inputs and perform a “join+select” function on the data sources 202 in order to allow for the mapping of the data to a form that may be utilized by specific components of the artifact embedding system 200, such as a layout engine 206, a search engine, or a list box for the selection or viewing of all the embedded artifacts, among others. Moreover, data may be received from multiple data sources 202, such as a data source with records for all the items with identifications (IDs), another data source with the latitude and longitude information for the items with the same IDs, and yet another data source with the grouping information for the items. In this case, a data mapper 204 may be used to perform a join on the common ID in order to provide unified data suitable for embedding artifacts within a map ES or within a content browser ES. For example, the map ES may specify information about a latitude, longitude, title, or description. The content browser ES, on the other hand, may specify information about a title, description, thumbnail, group ID, or item order.

The layout engine 206 within the artifact embedding system 200 may be responsible for the final layout of the embedded artifacts on the screen. The layout engine 206 may have a component that is tightly bound to the underlying experience stream and is intimately aware of its coordinate system, as well as a component that is general and can be shared across multiple experience streams. In some embodiments, the layout engine may be responsible for interacting with the data mappers 204, a filter engine 208, and an environmental policy engine 210. The layout engine 206 may also be responsible for interacting with an embedded object manager 212 and determining the visibility of embedded objects 214 on the screen, wherein the embedded objects 214 may include any types of embedded artifacts or highlights.

The filter engine 208 may be responsible for interacting with the pluggable data mappers 204 through the layout engine 204, as well as interacting directly with the pluggable embedded object managers 212 and a pluggable filter user experience (UX) module 216. Moreover, the state of the pluggable filter engine 208 may be defined by a query string and an exceptions list, which may contain references to specific items along with specific states for these items. The filter engine 208 may be responsible for processing the query string, applying the exceptions specified in the exception list, and providing the filtered items or embedded artifacts.

The filter UX module 216 may interface with the user and allow the user to select specific filter parameters for the embedded objects 214. For example, the filter UX module 216 may provide a list of available embedded artifacts to the user and allow the user to select a particular embedded artifact. Furthermore, the filter UX module 216 may include a highly-responsive search box that updates a results list of embedded artifacts in response to every keystroke. In some embodiments, the filter UX module 216 may be distinct from the filter engine 208 and may be used to provide a customized user experience based on, for example, a theme of an experience stream.

The pluggable environmental policy engine 210 within the artifact embedding system 200 may be responsible for implementing policies that specify certain behaviors of the embedded artifacts. Such behaviors may include, for example, a visibility of an embedded artifact, wherein the visibility may be controlled by a zoom level or a proximity of the viewport to the location of the embedded artifact. In addition, such behaviors may also include a state or visibility of the embedded artifacts, wherein the state or visibility of the embedded artifacts may be controlled by the density of the embedded artifacts in a given view.

Pluggable embedded object managers 212 may be responsible for creating UX controls for implementing the embedded objects 214 into an experience stream. For example, the embedded object managers 212 may instantiate the UX controls depending on which theme is in effect. In addition, the embedded object managers 212 may cache UX controls to enable smooth navigation, such as, for example, the panning and zooming of a map. The embedded object managers 212 may rely on the layout engine 206 to determine which set of embedded objects 214 to update or delete. Furthermore, different types of embedded object managers 212 may be utilized to provide the hosting environment for different types of embedded objects 214.

An experience stream interpreter 218 within the artifact embedding system 200 may be responsible for interpreting the keyframe, or small state, representation of an embedded artifact state and interacting with the layout engine 206 to enforce that state. For example, the experience stream interpreter 218 may enforce a “Play” or “Scripted Experience” state, or mode, of the embedded artifacts. Moreover, when in interactive mode, the experience stream interpreter 218 may act in the reverse direction by providing a keyframe representation of the current state.

FIG. 3 is a block diagram of an exemplary computing system 300 that may be used to implement the artifact embedding system 200. Like numbered items are as described with respect to FIG. 2. The computing system 300 may include any of a number of general-purpose or special-purpose computing system environments or configurations. Moreover, the computing system 300 may be any computing device having the computational capacity to implement at least the artifact embedding system 200. Such computing devices may include, but are not limited to, personal computers, server computers, hand-held computing devices, laptop or mobile computing devices, communications devices such as cell phones, multiprocessor systems, microprocessor-based systems, set top boxes, programmable consumer electronics, minicomputers, mainframe computers, and audio or video media players.

The computing system 300 may include a processor 302 that is adapted to execute stored instructions, as well as a memory device 304 that stores instructions that are executable by the processor 302. The processor 302 can be a single core processor, a multi-core processor, a computing cluster, or any number of other configurations. The memory device 304 can include random access memory (RAM), read only memory (ROM), flash memory, or any other suitable memory systems. The instructions stored by the processor 302 may be used implement a method for embedding artifacts within rich media. Moreover, the computing system 300 may also include a storage device 308 adapted to store the artifact embedding system 200. Furthermore, the artifact embedding system 200 may also be partially or fully included within the memory device 304.

A network interface controller 310 may be adapted to connect the computing system 300 through the bus 306 to a network 312. Through the network 312, electronic text and imaging input documents 314 may be downloaded and stored within the storage device 308. In addition, the computing system 300 may be linked through the bus 306 to a display interface 316 adapted to connect the computing system 300 to a display device 318, wherein the display device 318 may include a computer monitor, camera, television, projector, virtual reality display, or mobile device, among others. A human machine interface 320 within the computing system 300 may connect the system 300 to a keyboard 322 and a pointing device 324, wherein the pointing device 324 may include a mouse, trackball, touchpad, joy stick, pointing stick, stylus, or touchscreen, among others. An input/output (I/O) interface 326 may also be adapted to connect the computing system 300 to any number of additional I/O devices 328. The I/O device 328 may include, for example, a camera, printer, scanner, mobile device, external hard drive, or Universal Serial Bus (USB) device.

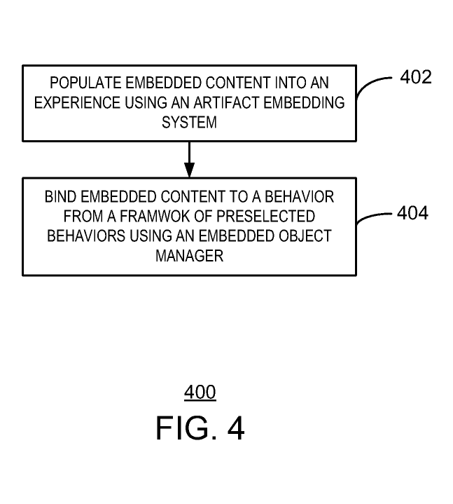

FIG. 4 is a process flow diagram showing a method 400 for embedding content in rich media. In various embodiments, the rich media may be an experience within a RIN, or any other type of media used for interactive exploration. The method may begin at block 402 with the population of embedded content from a data stream within an experience using an artifact embedding system. The embedded content may include data obtained from any number of data sources. The embedded content may include video data, image data, or audio data, or any combinations thereof. Moreover, the embedded content may also include any type of complex media, such as gigapixel panoramas and hierarchical tile sets.

In some embodiments, prior to populating the embedded content within the experience, the embedded content may be mapped into a desired form using a data mapper. The desired form may be any form that is suitable for use by the artifacts embedding system. Moreover, specific components of the artifact embedding system may be configured to utilize different forms of data.

In addition, the embedded content may be converted into a desired layout using a layout engine. The desired layout may be highly-variable and may depend on the specific experience within which the embedded content is to be populated, as well as the individual preferences of a user of the artifact embedding system. Furthermore, the embedded content may be filtered using a filter engine or a filter UX, or both. The filter engine may automatically filter the embedded content based on specific, predetermined conditions, such as the type of embedded content which may be supported by a particular experience. The filter UX may allow the user of the artifact embedding system to search for and individually select specific embedded content based on, for example, the user's preferences or the theme of the experience.

An embedded object manager may be used to assist in the population of the embedded content within the experience of the RIN. The embedded content may be populated within the experience according to a variety of methods. For example, the embedded content may be tethered loosely to the media of the experience. The embedded content may be embedded tightly within the media of the experience. Moreover, the embedded content may not be tied to the media of the experience but, instead, may simply float in a separate layer above the media of the experience. In some cases, such floating embedded content may have layout constraints which keep the content in a specific layer above the media.

At block 404, the embedded content may be bound to a behavior from a framework of preselected behaviors using the embedded object manager. The framework of preselected behaviors may include a number of possible behaviors to which the embedded content may be bound. Moreover, the framework of preselected behaviors may be implemented according to a binding language. The binding language may be adapted to direct the binding of embedded content to any of the preselected behaviors within a computing environment.

In various embodiments, the embedded content may be bound to a specific behavior from the framework of preselected behaviors, or may be bound to any number of the behaviors from the framework. For example, a state of the embedded content may be keyframed in order to create a small state representation of the embedded content. The small state representation may then be scripted as part of a fly-through or a playback within the experience. Multiple keyframes may also be created and then combined in order to create a smooth transition of the embedded content with the experience. In some embodiments, a theme may be incorporated for the embedded content, or the embedded content may be adapted to fit a theme of the experience within which the content is located. Examples of possible themes for the embedded content may be a “Classic” theme, a “Friendly” theme, or a “Metro” theme, among others. Moreover, the embedded content may be animated according to the preferences of a user. The animation of the embedded content may then be played during a predetermined time during the playback of the RIN or may be played in response to a user interaction, such as in response to a user's click on a specific icon relating to the animation.

Another preselected behavior may include the incorporation of narrative-specific highlights into the embedded content. In some embodiments, the narrative-specific highlights may include features which call attention to specific regions of the embedded content by causing the specific regions to become enlarged or brighter, for example, using a spotlight effect that highlights a particular feature within an image experience. Moreover, environmental parameters may also be incorporated into the embedded content. In various embodiments, the incorporation of the environmental parameters may be directed by an environmental policy engine. The environmental parameters may include, for example, a visibility, a volume, a size, a form, an orientation, or a state of the embedded content. Further, the environmental parameters may also include a zoom level of the data, a density level of the data, or a proximity to a viewport of the data.

Moreover, the method 400 is not intended to indicate that the steps of the method 400 are to be executed in any particular order or that all of the steps are to be present in every case. Further, steps may be added to the method 400 according to the specific application. For example, any number of additional preselected behaviors may also be used in conjunction with the method 400. Furthermore, the preselected behaviors described above may be extensible, meaning that they may be altered at any point in time in order to add or delete specific features of the embedded content.

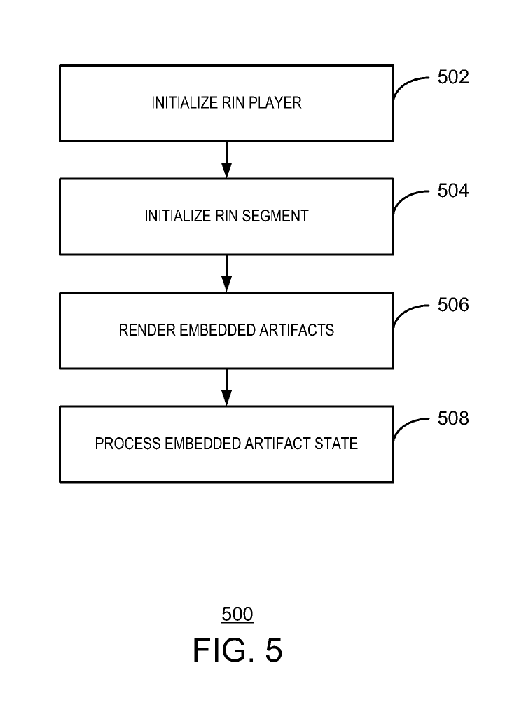

FIG. 5 is a block diagram of a method 500 for embedding artifacts within rich media and processing the embedded artifact (EA) state. In various embodiments, the steps of the method 500 may be partially or fully incorporated within the steps of the method 400. The method 500 begins at block 502 with the initialization of the RIN player. This may be accomplished by consulting manifests and a table mapping various entities to concrete resources. The various entities may include EA data source uniform resource locators (URLs), EA object types, filter engine IDs, environmental module IDs, filter UX IDs, embedded object manager IDs, or embedded artifact type IDs, among others. The concrete resources may include style sheets, media, or code, among others.

At block 504, the RIN segment may be initialized. This may be accomplished by reading references to EA data sources from the auxiliary data for each ES in the RIN data file. The corresponding EA providers, data mappers, and layout engines, for example, may be loaded. The components may be bound to each other by exchanging pointers and handles. Optionally, the EAs may be pre-loaded and cached given the initial keyframe value for each ES. This may allow for quick rendering.

At block 506, the embedded artifacts may be rendered according to the initial state of the experience. Moreover, at block 508, the embedded artifact state may be processed each time there is an update to the state of the experience. In some embodiments, an update to the state of the experience may occur in response to a scripted interaction. In this case, the source of the updated EA state is the keyframe data present in the ES. Further, in some embodiments, an update to the state of the experience may occur in response to a user interaction with the experience. In this case, the source of the updated EA state is a manipulation of the ES, the search query, or the individual ES state by the user. The manipulation of the ES may occur by, for example, panning or zooming, while the manipulation of the ES may occur, for example, via the search engine UX.

Processing the EA state at block 508 may include determining if a query string is present. If the query string is present, the query string may be sent to the filter engine to update the filter state. The filter engine may update its internal query state, which determines which EAs are visible by default. Furthermore, it may be determined whether an exceptions list is present. In various embodiments, an exceptions list includes a list of EA item identifiers, grouped by source or type of EA. Each AE item identifier may include a record that contains small state slivers that specify the state of the EA. The state of the EA may include a mode of the EA (e.g., hidden, minimized, inset, or maximized), a media state of the EA, and whether the EA is itself a RIN segment. In some embodiments, if an exceptions list is present, the previous or default small state of an EA may be overridden with the state in the exceptions list for the EA.

For each EA, the current state may be queried. If the new state is different from a previous state, the embedded object manager may be notified about the updated state. The embedded object manager may then notify the pluggable controls implementing the EA to update the state of the EA. In various embodiments, such updates may be batched, so that each embedded object manager is given a list of updates for each type of EA.

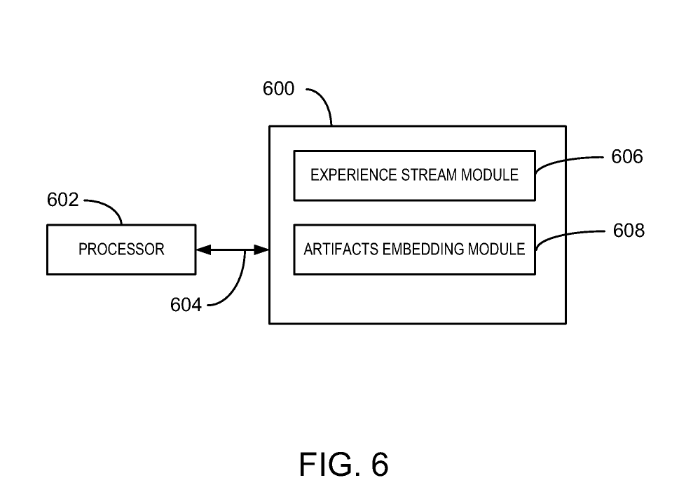

FIG. 6 is a block diagram showing a tangible, non-transitory, computer-readable medium 600 that stores code adapted to allow for the embedding of content in rich media. The tangible, non-transitory, computer-readable medium 600 may be accessed by a processor 602 over a computer bus 604. Furthermore, the tangible, non-transitory, computer-readable medium 600 may include code configured to direct the processor 602 to perform the steps of the current method.

The various software components discussed herein may be stored on the tangible, non-transitory, computer-readable medium 600, as indicated in FIG. 6. For example, an experience stream module 606 may be configured to generate an interactive experience stream for interfacing with a user. In addition, an artifacts embedding module 608 may be configured to embed artifacts within rich media, such as within an interactive experience stream generated by the experience stream module 606. Moreover, in some embodiments, the artifacts embedding module 608 may be located within the experience stream module 606.

The block diagram of FIG. 6 is not intended to indicate that the tangible, non-transitory, computer-readable medium 600 includes both the software components 606 and 608 in every case. Furthermore, the tangible, non-transitory, computer-readable medium 600 may include additional software components not shown in FIG. 6. For example, in some embodiments, the experience stream module 606 may include the data binding module 102 and the trajectory module 104, as discussed with respect to FIG. 1A. In addition, in some embodiments, the artifacts embedding module 608 may include a data mapper module, a layout engine module, an environmental policy engine module, a filter engine module, a filter UX module, an experience stream interpreter module, or an embedded object manager module, among others.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for embedding content in rich media, comprising:
populating embedded content from a data stream into an experience using an artifact embedding system; and
binding the embedded content to a behavior from a framework of preselected behaviors using an embedded object manager.

2. The method of claim 1, wherein binding the embedded content to the behavior comprises:
keyframing a state of the embedded content;
incorporating a theme for the embedded content;
animating the embedded content;
incorporating narrative-specific highlights into the embedded content; or
incorporating environmental parameters into the embedded content; or
any combinations thereof.

3. The method of claim 2, wherein keyframing the state of the embedded content comprises creating a small state representation of a state of the embedded content.

4. The method of claim 3, comprising scripting the small state representation as part of a fly-through or a playback within the rich media.

5. The method of claim 2, wherein animating the embedded content comprises playing an animation of the embedded content at a predetermined time during a playback of the rich media or in response to a user interaction.

6. The method of claim 2, wherein incorporating environmental parameters into the embedded content comprises incorporating a visibility, a volume, a size, a form, an orientation, or a state of the embedded content.

7. The method of claim 1, comprising binding the embedded content to an extensible set of behaviors in a platform-independent manner according to a binding language.

8. The method of claim 1, comprising designating a mode for the rich media, wherein the mode comprises a “Play” mode or a “Scripted Experience” mode.

9. The method of claim 1, wherein populating the embedded content within the experience comprises:
tethering the embedded content loosely to media within the experience;
embedding the embedded content tightly within the media within the experience; or
floating the embedded content in a separate layer above the media within the experience; or
any combinations thereof.

10. The method of claim 1, wherein the rich media comprises a Rich Interactive Narrative (RIN).

11. A system for embedding content in rich media, comprising an artifact embedding system configured to:
obtain data from a data source;
map the data into a desired form using a data mapper;
convert the data into a desired layout using a layout engine;
embed the data within rich media, wherein the data comprise embedded content; and
bind the data to a behavior from a framework of preselected behaviors using an embedded object manager.

12. The system of claim 11, wherein the behavior comprises a keyframing of the data.

13. The system of claim 11, wherein the embedded content comprises a pasted on part and an overlay part.

14. The system of claim 11, wherein the rich media comprise an experience within a rich interactive narrative (RIN).

15. The system of claim 14, wherein the embedded content comprises a second RIN that is embedded within the RIN.

16. The system of claim 11, wherein the rich media comprise video media, image media, or audio media, or any combinations thereof.

17. The system of claim 11, wherein the behavior comprises a zoom level of the data, a density level of the data, or a proximity to a viewport of the data, or any combinations thereof, controlled by an environmental policy engine.

18. The system of claim 11, wherein the behavior comprises a rendering of a small state representation of the data.

19. One or more tangible, non-transitory, computer-readable storage media for storing computer-readable instructions, the computer-readable instructions providing an artifact embedding system when executed by one or more processing devices, the computer-readable instructions comprising code configured to:
obtain data from a data source using the artifact embedding module;
map the data into a desired format;
determine a desired layout and desired parameters for the data;
populate the data within rich media according to the desired layout and the desired parameters; and
bind the data to any of a plurality of preselected behaviors.

20. The one or more tangible, non-transitory, computer-readable storage media of claim 19, wherein the plurality of preselected behaviors comprises:
a keyframing of a state of the data;
an incorporation of a theme or highlights into the data, or both; or
an animation of the embedded content; or
any combinations thereof.
